(19) United States
(12) Patent Application Publication
(10) Pub. No.: US 2020/0409950 A1
(43) Pub. Date: Dec. 31, 2020

(54) DETECTING ANOMALIES IN SEASONAL MULTIVARIATE TIME SERIES DATA

(71) Applicant: International Business Machines Corporation, Armonk, NY (US)

(72) Inventor: Mu Qiao, Belmont, CA (US)

(21) Appl. No.: 16/451,352

(22) Filed: Jun. 25, 2019

(51) Int. Cl. G06F 16/2458

(52) U.S. Cl. CPC G06F 16/2465; G06F 16/2474

(57) ABSTRACT

A computer-implemented method for detecting anomalies in seasonal multivariate time series data is described. A non-limiting example of the computer-implemented method includes receiving, by a processor, sensor data from a sensor and computing, by the processor, common trends from the sensor data. The method detrends, by the processor, the common trends into detrended data and computes, by the processor, common seasonality from the sensor data. The method deseasonalizes, by the processor, the common seasonality into deseasonalized data. The method obtains, by the processor, remainder components using the detrended data and desesonalized data and identifies, by the processor, remainder components as an anomaly when remainder components are greater than k standard deviations away from zero, where k is a user specified threshold greater than or equal to two.

### BACKGROUND

The present invention generally relates to testing systems, and more specifically, to detecting anomalies in seasonal multivariate time series data.

Seasonal multivariate time series data are common in the real world, for instance, in healthcare monitoring, financial transactions, retail, and internet of things (“IOT”). Each variable or dimension in the multivariate time series exhibits seasonality. The variables have correlations, i.e., they are not independent. For instance, in server monitoring, CPU utilization can be correlated with network throughput. In another example, in healthcare monitoring, heartbeat rate can be correlated with breathing rate. Different metrics therefore can share common trends. In addition, the seasonal patterns can also be shared among variables. For instance, in retail, household electronics and jewelry sales have a spike around the Christmas season, and textbooks and backpacks show an increase around the start of a school year.

Anomaly, or outlier, detection is the identification of items, events, or observations which do not conform to an expected pattern or other items in a dataset. Anomalies can be detected from multivariate or multidimensional time series. There are many applications that use anomaly detection in seasonal multivariate time series data, including, monitoring server performance, monitoring Internet-of-Things (“IOT”) devices, fraud detection, and process controls.

### SUMMARY

Embodiments of the present invention are directed to a computer-implemented method for detecting anomalies in seasonal multivariate time series data. A non-limiting example of the computer-implemented method includes receiving, by a processor, sensor data from a sensor and computing, by the processor, common trends from the sensor data. The method detrends, by the processor, the common trends into detrended data and computes, by the processor, common seasonality from the sensor data. The method deseasonalizes, by the processor, the common seasonality into deseasonalized data. The method obtains, by the processor, remainder components using the detrended data and desesonalized data and identifies, by the processor, remainder components as an anomaly when remainder components are greater than k standard deviations away from zero, where k is a user specified threshold, e.g., k is equal to two. The higher the value of k, the more stringent the anomaly detection.

Embodiments of the present invention are directed to a system for detecting anomalies in seasonal multivariate time series data. A non-limiting example of the system includes a processor in communication with one or more types of memory. The processor is configured to perform a method. The method receives, by the processor, sensor data from a sensor and computing, by the processor, common trends from the sensor data. The method detrends, by the processor, the common trends into detrended data and computes, by the processor, common seasonality from the sensor data. The method deseasonalizes, by the processor, the common seasonality into deseasonalized data. The method obtains, by the processor, remainder components using the detrended data and desesonalized data and identifies, by the processor, remainder components as an anomaly when remainder components are greater than k standard deviations away from zero, where k is a user specified threshold, e.g., k is equal to two.

Embodiments of the invention are directed to a computer program product for detecting anomalies in seasonal multivariate time series data, the computer program product comprising a computer readable storage medium having program instructions embodied therewith. The program instructions are executable by a processor to cause the processor to perform a method. A non-limiting example of the method includes receiving, by the processor, sensor data from a sensor and computing, by the processor, common trends from the sensor data. The method detrends, by the processor, the common trends into detrended data and computes, by the processor, common seasonality from the sensor data. The method deseasonalizes, by the processor, the common seasonality into deseasonalized data. The method obtains, by the processor, remainder components using the detrended data and desesonalized data and identifies, by the processor, remainder components as an anomaly when remainder components are greater than k standard deviations away from zero, where k is a user specified threshold, e.g., k is equal to two.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a high-level block diagram computer system, which can be used to implement one or more aspects of the present invention; and

FIG. 4 depicts a flowchart of an iteration of an anomalies detection method according to embodiments of the invention.

The diagrams depicted herein are illustrative. There can be many variations to the diagrams or the operations described therein without departing from the spirit of the invention. For instance, the actions can be performed in a different order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

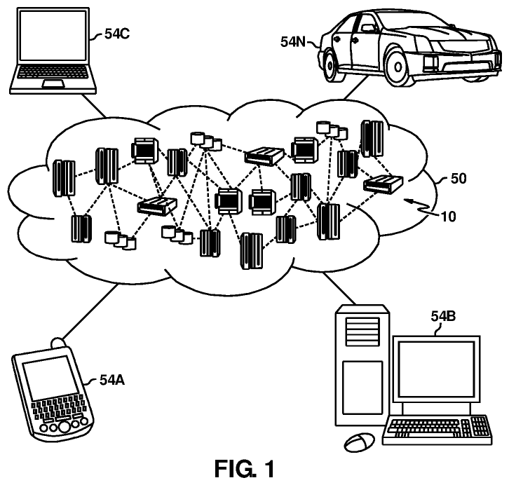

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

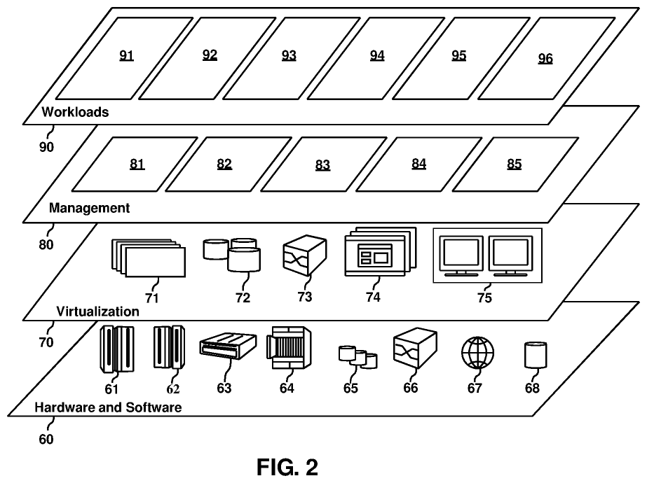

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; anomalies process 95; and time series data processing 96.

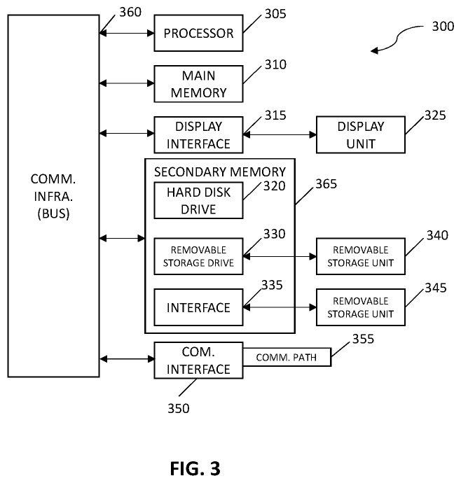

FIG. 3 depicts a high-level block diagram computer system 300, which can be used to implement one or more aspects of the present invention. More specifically, computer system 300 can be used to implement some hardware components of embodiments of the present invention. Although one exemplary computer system 300 is shown, computer system 300 includes a communication path 355, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 355, e.g., to communicate data between them.

Computer system 300 includes one or more processors, such as processor 305. Processor 305 is connected to a communication infrastructure 360 (e.g., a communications bus, cross-over bar, or network). Computer system 300 can include a display interface 315 that forwards graphics, text, and other data from communication infrastructure 360 (or from a frame buffer not shown) for display on a display unit 325. Computer system 300 also includes a main memory 310, preferably random access memory (RAM), and can also include a secondary memory 365. Secondary memory 365 can include, for example, a hard disk drive 320 and/or a removable storage drive 330, representing, for example, a floppy disk drive, a magnetic tape drive, or an optical disk drive. Removable storage drive 330 reads from and/or writes to a removable storage unit 340 in a manner well known to those having ordinary skill in the art. Removable storage unit 340 represents, for example, a floppy disk, a compact disc, a magnetic tape, or an optical disk, etc. which is read by and written to by removable storage drive 330. As will be appreciated, removable storage unit 340 includes a computer readable medium having stored therein computer software and/or data.

In alternative embodiments, secondary memory 365 can include other similar means for allowing computer programs or other instructions to be loaded into the computer system. Such means can include, for example, a removable storage unit 345 and an interface 335. Examples of such means can include a program package and package interface (such as that found in video game devices), a removable memory chip (such as an EPROM, or PROM) and associated socket, and other removable storage units 345 and interfaces 335 which allow software and data to be transferred from the removable storage unit 345 to computer system 300.

Computer system 300 can also include a communications interface 350. Communications interface 350 allows software and data to be transferred between the computer system and external devices. Examples of communications interface 350 can include a modem, a network interface (such as an Ethernet card), a communications port, or a PCM-CIA slot and card, etcetera. Software and data transferred via communications interface 350 are in the form of signals which can be, for example, electronic, electromagnetic, optical, or other signals capable of being received by communications interface 350. These signals are provided to communications interface 350 via communication path (i.e., channel) 355. Communication path 355 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 310 and secondary memory 365, removable storage drive 330, and a hard disk installed in hard disk drive 320. Computer programs (also called computer control logic) are stored in main memory 310 and/or secondary memory 365. Computer programs can also be received via communications interface 350. Such computer programs, when run, enable the computer system to perform the features of the present invention as discussed herein. In particular, the computer programs, when run, enable processor 305 to perform the features of the computer system. Accordingly, such computer programs represent controllers of the computer system.

Turning now to an overview of technologies that are more specifically relevant to aspects of the invention, many methodologies have existed in the past to detect anomalies in seasonal multivariate time series data, but they all have flaws. A first method, multivariate time series modeling through vector auto regression is widely used in economics and finance. Each variable is a linear function of past lags of itself and the lags of other variables. In vector auto regression, a trend can be included as deterministic regressors and seasonal dummy variables can be included as exogenous regressors. However, only a single common trend and a single common seasonality can be modeled. We are considering multiple common trends and common seasonality.

A second method that has been tried is seasonal trend decomposition, specifically a seasonal trend decomposition procedure based on Loess (“STL”). STL uses a time series composed of three components, trend, seasonal, and remainder. But, STL can only decompose univariate time series. A third method attempted has been a local outlier factor (“LOF”) and supervised classifiers, such as logistic regression and random forest. But these methodologies discard temporal patterns.

Turning now to an overview of the aspects of the invention, one or more embodiments of the invention address the above-described shortcomings of the prior art by providing a method to detect anomalies from multivariate time series in the presence of seasonality and trend through the following stages. Acquiring the multivariate time series data by sensors of devices that monitor device conditions, or some other means. The multivariate time series data is decomposed into a common trend, common seasonal, and remainder components through an iterative and an alternative updating process, where the estimations of seasonal and trend components are mutually dependent upon each other. The remaining components are used to detect anomalies following a k-σ rule in Gaussian distribution, where k is a user specified threshold and a is the standard deviation of all the remainders. For example, if the remainder component is two standard deviations away from zero, it is considered to be abnormal.

The above-described aspects of the invention address the shortcomings of the prior art by providing the above methodology in a system or method to suppress sudden spikes in model estimation by considering common factors among multiple variables. It avoids false positives caused by a sudden change in a time series graduated over many time periods. In prior systems, the time series estimation is easily affected by spikes in the data and introduces artificial anomalies into the detection.

The methodology described herein significantly improves computer operation by allowing accurate anomaly detection in seasonal multivariate time series data that is generated by a computer operating system and hardware operation. Prior systems would miss such anomalies or would generate false positives, thus negatively impacting computer system performance.

The described method decomposes a seasonal multivariate time series into three components: common seasonality, common trend, and remainder. The decomposition consists of an interative procedure. Each pass consists of a trend estimation that updates the common trends using dynamic factor analysis (“DFA”), followed by a seasonal estimation that updates the common seasonal components. Suppose Sₜ^{(l)} and CTₜ^{(l)}, for all times t=1 to T, are the seasonal and common trend components of a multivariate time series Yₜ at the end of the lth pass. The updates Sₜ^{(l+1)} and CTₜ^{(l+1)} in the (l+1)th pass are computed in the following way.

Common trends are computed by applying dynamic factor analysis to obtain the common trends: CTₜ^{(l+1)}=DFA(Yₜ). Next, detrending occurs where a detrended series, Yₜ−CTₜ^{(l+1)} is computed. Common seasonality is computed by applying existing methods (such as dynamic factor analysis) to compute the common seasonal components among variables to obtain Sₜ^{(l+1)}. Lastly, deseasonalizing is computed by computing a deseasonalized series, Yₜ−Sₜ^{(l+1)} The above steps iterate.

After the common seasonal and trend components are estimated, final remainder components are obtained. The k-σ rule in Gaussian distribution is applied to the remaining component of each variable to detect anomalies. If k is set at 2, i.e., the remaining components is two standard deviations away from 0, the corresponding data point on that dimension is considered to be abnormal. The higher the value of k, the more stringent the anomaly detection. Depending upon the anomaly definition, the method identifies the data points whose corresponding dimensions are considered as abnormal.

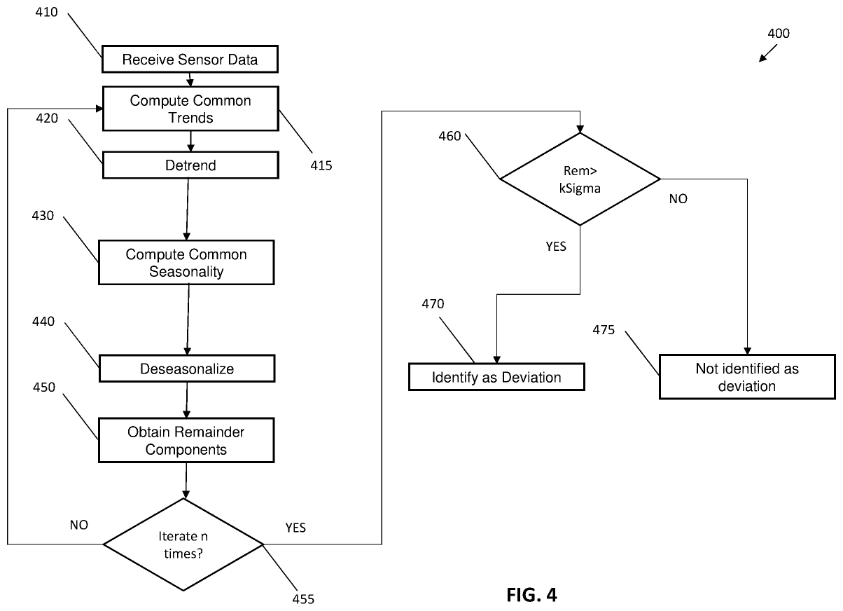

Turning now to a more detailed description of aspects of the present invention, FIG. 4 depicts a flowchart of an iteration of an anomalies detection method 400 according to embodiments of the invention. The following discussion of the method is with respect to the method running on the computer depicted in FIG. 3, although it also applies to the cloud computing system of FIGS. 1 and 2. The method 400 runs repeated from time t=0 to time t=T. Starting at time, t=0, sensor data is received by processor 305. (Stage 410). Common trends are computed by processor 305 (Stage 415). Common trends are computed by processor 305 by applying dynamic factor analysis to obtain the common trends: CTₜ^{(l+1)}=DFA(Yₜ).

Processor 305 computes a detrended series, Yₜ−CTₜ^{(l+1)}. (Stage 420). Common seasonality is computed by processor 305 by applying existing methods (previously described) to compute the common seasonal components among variables to obtain Sₜ^{(l+1)}. (Stage 430). Deseasonalizing is computed by processor 305 by computing a deseasonalized series, Yₜ−Sₜ^{(l+1)}. (Stage 440). Processor 305 obtains remainder components. (Stage 450). The above steps iterate n times, where n is a user specified parameter. (Stage 455).

After the iteration, Processor 305 checks to see if the remaining components are greater than kSigma away from 0. (Stage 460). If yes, the remainder is identified as a deviation or anomaly. (Stage 470). If no, the remainder is not identified as a deviation or anomaly. (Stage 475).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, sensor data from a sensor;
computing, by the processor, common trends from the sensor data;
detrending, by the processor, the common trends into detrended data;
computing, by the processor, common seasonality from the sensor data;
deseasonalizing, by the processor, the common seasonality into deseasonalized data;
obtaining, by the processor, remainder components using the detrended data and desesonalized data; and
identifying, by the processor, remainder components as an anomaly when remainder components are greater than k standard deviations away from zero, where k is a user specified threshold greater than or equal to two.

2. The computer-implemented method of claim 1, further comprising providing, by the processor, the identified anomalies to a user.

3. The computer-implemented method of claim 1, wherein computing the common trends comprises applying dynamic factor analysis by the processor.

4. The computer-implemented method of claim 1, wherein detrending comprises subtracting the common trends from the sensor data by the processor.

5. The computer-implemented method of claim 1, wherein common seasonality includes computing, by the processor, common seasonal components.

6. The computer-implemented method of claim 5, wherein common seasonal components are computed by the processor, by applying dynamic factor analysis.

7. The computer-implemented method of claim 1, wherein deseasonalizing comprises subtracting the common seasonal components from the sensor data by the processor.

8. A computer program product for detecting anomalies in seasonal multivariate time series data, the computer program product comprising:
a computer readable storage medium readable by a processing circuit and storing program instructions for execution by the processing circuit for performing a method comprising:
receiving, by the processing circuit, sensor data from a sensor;
computing, by the processing circuit, common trends from the sensor data;
detrending, by the processing circuit, the common trends into detrended data;
computing, by the processing circuit, common seasonality from the sensor data;
deseasonalizing, by the processing circuit, the common seasonality into deseasonalized data;
obtaining, by the processing circuit, remainder components using the detrended data and desesonalized data; and
identifying, by the processing circuit, remainder components as an anomaly when remainder components are greater than k standard deviations away from zero, where k is a user specified threshold greater than or equal to two.

9. The computer program product of claim 8, wherein the method further comprises providing, by the processing circuit, the identified anomalies to a user.

10. The computer program product of claim 8, wherein computing the common trends comprises applying dynamic factor analysis by the processing circuit.

11. The computer program product of claim 8, wherein detrending comprises subtracting the common trends from the sensor data by the processing circuit.

12. The computer program product of claim 8, wherein common seasonality includes computing, by the processing circuit, common seasonal components.

13. The computer program product of claim 12, wherein common seasonal components are computed by the processing circuit, by applying dynamic factor analysis.

14. The computer program product of claim 8, wherein deseasonalizing comprises subtracting the common seasonal components from the sensor data by the processing circuit.

15. A processing system for detecting anomalies in seasonal multivariate time series data, the processor system comprising:
a processor in communication with one or more types of memory, the processor configured to perform a method comprising:
receiving, by a processor, sensor data from a sensor;
computing, by the processor, common trends from the sensor data;
detrending, by the processor, the common trends into detrended data;
computing, by the processor, common seasonality from the sensor data;
deseasonalizing, by the processor, the common seasonality into deseasonalized data;
obtaining, by the processor, remainder components using the detrended data and desesonalized data; and
identifying, by the processor, remainder components as an anomaly when remainder components are greater than k standard deviations away from zero, where k is a user specified threshold greater than or equal to two.

16. The processing system of claim 15, the method performed further comprising providing, by the processor, the identified anomalies to a user.

17. The processing system of claim 15, wherein computing the common trends comprises applying dynamic factor analysis by the processor.

18. The processing system of claim 15, wherein detrending comprises subtracting the common trends from the sensor data by the processor.

19. The processing system of claim 15, wherein common seasonality includes computing, by the processor, common seasonal components.

20. The processing system of claim 19, wherein common seasonal components are computed by the processor, by applying dynamic factor analysis.
